(19) United States
(12) Patent Application Publication
(10) Pub. No.: US 2002/0162670 A1
(43) Pub. Date: Nov. 7, 2002

(54) Multi-ended cable tie

(76) Inventor: D?apos;wayne R. Netherland, Vacaville, CA (US)

Correspondence Address: William S. Bernheim, 255 N. Lincoln St., Dixon, CA, 95620, US

(21) Appl. No.: 09/850,620

(22) Filed: May 7, 2001

(51) Int. Cl. H01B 1/00

(52) U.S. Cl. 174/1; 439/801; 174/135

(57) ABSTRACT

A double ended fastener for use with excess cable tie tail to form a second cable tie.

### BACKGROUND OF THE INVENTION

1. Field of the Invention

This invention relates generally to cable ties and an apparatus consisting of a double ended fastener for use with a cable tie tail.

2. Description of the Prior Art

Cable ties are well known and used in an almost endless variety of applications, including binding cables together and securing pump mounts to bicycles. The cable consists of a locking head and a cable tail. The tail has continuous parallel ridges along its length. The head has a locking tab which interacts with a parallel ridge allowing the head of the tail to pass through the locking head in one direction and to be locked at each ridge successively. The circumference described by the tail passing through the head can thus be reduced by further drawing the tail through the head. Items such as cables within the circumference described are drawn together as the tail is drawn through the head. The locking feature prevents the items once drawn together from inadvertently being allowed to separate. Typically the cable ties are inexpensive and are designed for one time use. The locking tab can be depressed with a tool to allow backing out of the tail, but can result in the tab losing its resiliency and the tie being no longer securely held.

Once secured the portion of the tail which has passed through the tab becomes a liability for such reasons as being a loose end, unsightly, unnecessary weight or a snag point. Frequently the excess tail is cut off and discarded.

### SUMMARY OF THE INVENTION

### OBJECTS OF THE INVENTION

It is an object of this invention to provide a new use for the portion of the cable tail which has passed through the locking head.

A further object is to provide cable tie apparatus which can be employed to form two or more complete ties employing one cable tail.

These and other objects and advantages will be apparent to those skilled in the art in light of the following disclosure, claims and accompanying drawings.

### DESCRIPTION OF THE DRAWINGS

FIG. 1 is a not-to-scale drawing of a cable tie with a detachable double headed fastener in accordance with the invention.

FIG. 2 is a not-to-scale drawing of a second use in which a cable tail is interacting with a double headed fastener in accordance with the invention.

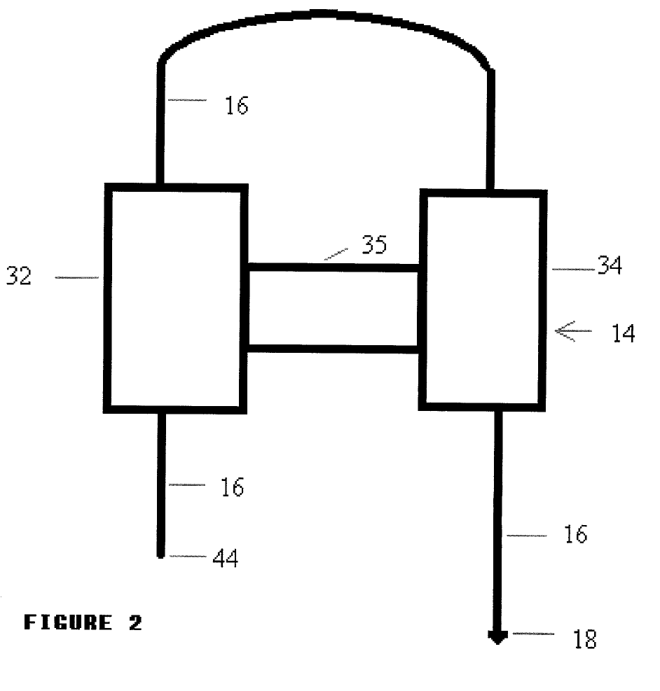

### DESCRIPTION OF PREFERRED EMBODIMENT

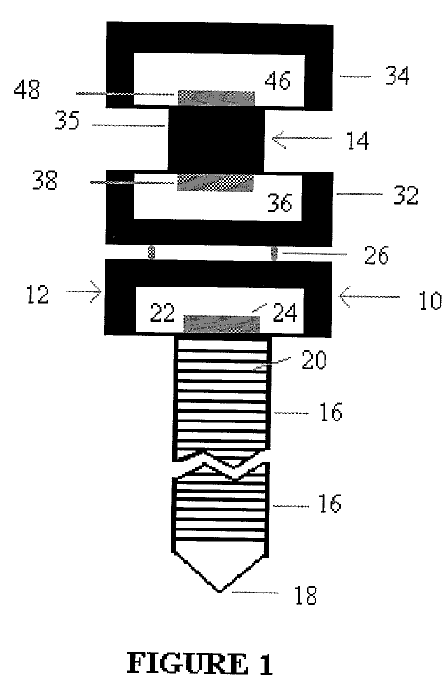

Referring to FIG. 1 a cable tie 10 in accordance with the invention includes a first locking head 12 and one or more detachable double headed fasteners 14. A cable tail 16 extends from the first locking head 12 and has a distal end 18. The cable tail 16 has continuous parallel ridges 20 along the length of one side of the tail 16. The first locking head 12 includes a rectangular opening 22 sized to receive the end 18 of tail 16 and allow the tail 16 to move through the opening 22. A locking tab 24 is integral to one side of the opening 22 and the tab 24 is spring loaded to extend into the opening 22 to interact with one of the parallel ridges 20 to allow the end of the tail to pass through the locking head in one direction and be locked at each ridge 20 successively. The circumference described by the tail 16 passing through the head 12 can thus be reduced by further drawing the tail 16 through the head 12.

As a separate piece or detachably attached with tabs 26 or the like to the first locking head 12 is a double headed locking fastener 14. The purpose of attachment is to prevent misplacement and assure availability when needed. The fastener 14 is a short piece having at one end a holding head 32 and at the distal end a second locking head 34 preferably identical to the first locking head 12 and interacting with a cable tail 16 in the same manner. Connecting the two heads 32 and 34 is a connector piece 35. Piece 35 is preferably between ½″ and 1″ in length. A shorter piece allows cinching of smaller items. A longer piece gives more space to work in.

The holding head 32 preferably includes a rectangular opening 36 sized to the tail 16 and includes a locking mechanism 38. The locking mechanism 38 is required to lock in the opposite direction in interacting with the tail 16. This locking can be provided by putting one or more reversed ridges on the opposite side of the tail 16 to the parallel ridges or by use of a modified tab interacting with the parallel ridges 20.

The fastener 14 is used after the cable tail 16 has been used with the first locking head 12 in an application such as securing cables into a bundle. If not already separated, the fastener 14 is detached from the first locking head 12. After initial use there is typically a portion of the tail 16 which has now passed through the first locking head 12 and so is no longer needed and can be described as excess cable tail 42. This excess cable tail 42 is made available by cutting through the cable tail 16 at a point along the tail 16 which has passed through the first locking head 12. In the past, such excess has been discarded or if uncut simply left undisturbed. This invention gives this excess material new value. Depending on the length of the tail and size of bundles, the process can be repeated and the excess tail after the second bundle ultilized with a second fastener 14.

The excess tail 42 has a cut end 44 and the distal end 18. Taking the fastener 14 the cut end 44 of the tail 16 is secured by passing the cut end 44 through the opening of the holding head 32 and securing thereby. Thereafter the excess tail 42 is placed around the material to be bundled and the distal end 18 passed through the second locking head 34 of the fastener 14 to form a cable tie which can tightened by drawing the distal end 18 further through the head 34. The holding head 34 preferably includes a rectangular opening 46 sized to the tail 16 and includes a locking mechanism 48.

It is to be appreciated that a long tail 16 or small bundle may result in sufficient excess tail end after use of a fastener 14 so that use of an additional fastener 14 may be possible or appropriate to form yet a third cable tie.

Although the invention has been shown and described with respect to preferred embodiments thereof, it should be understood by those skilled in the art that various changes and omissions in the form and detail thereof may be made therein without departing from the spirit and scope of the invention as defined in the appended claims.

I claim:

1. A fastener for use with a cable tie tail comprising a short piece having at one end a holding head and at the distal end a second locking head such that the holding head interacts to lock with a cut end of the cable tie and the locking head interacts with the distal end of the tail.

2. A cable tie having a first locking head and a cable tail and further including a detachable fastener for use with the cable tie tail comprising a short piece having at one end a holding head and at the distal end a second locking head such that the holding head interacts to lock with a cut end of the cable tie and the locking head interacts with the distal end of the tail.

3. A cable tie of claim 2 including more than one detachable fastener.

4. A cable tie having a tail with parallel ridges on one side and a reverse ridge on the opposite side of the tail.

5. A cable tie of claim 2 wherein the cable tail has parallel ridges on one side and one or more reverse ridges on the opposite side of the tail.
